(19) United States
(12) Patent Application Publication
(10) Pub. No.: US 2024/0340033 A1
(43) Pub. Date: Oct. 10, 2024

(54) ADAPTER, TRANSCEIVER SYSTEM AND METHOD FOR OPERATING AN ADAPTER

(71) Applicant: FLEXOPTIX GMBH, Darmstadt (DE)

(72) Inventors: David Elias ÖNAL, Darmstadt (DE); Thomas WEIBLE, Darmstadt (DE); Markus ARNOLD, Darmstadt (DE)

(73) Assignee: FLEXOPTIX GMBH, Darmstadt (DE)

(21) Appl. No.: 18/579,295

(22) PCT Filed: Jul. 19, 2022
(86) PCT No.: PCT/EP2022/070112

§ 371 Date: Jan. 12, 2024

(30) Foreign Application Priority Data
Jul. 26, 2021 (DE) 10 2021 119 317.6

(51) Int. Cl. H04B 1/3827; H01R 33/94

(52) U.S. Cl. CPC H04B 1/3827; H01R 33/94

(57) ABSTRACT

The invention relates to an adapter, in particular for a mobile transceiver configuration device, having an adapter unit which comprises a communication interface for communication with an external unit by means of a first communication protocol, an adapter interface for communication with an additional unit, in particular the transceiver configuration device, by means of a second communication protocol, and a converter unit for converting between the first communication protocol and the second communication protocol. In order to provide a generic device having improved properties in terms of flexibility, it is proposed that the adapter has a power supply unit for the autonomous power supply of at least the adapter unit.

### PRIOR ART

The invention relates to an adapter according to the preamble of claim 1, a transceiver system according to claim 13 and a method for operating the adapter according to the preamble of claim 14.

An adapter according to the preamble of claim 1 is already known from the prior art. In addition, such an adapter from the prior art always has a connection interface to an external power supply source, wherein the external power supply source supplies at least the adapter with power in an operating state.

The object of the invention is in particular to provide a generic device which has improved properties with regard to flexibility. The object is achieved according to the invention by the features of claims 1, 13 and 14, while advantageous embodiments and further developments of the invention can be derived from the subclaims.

### Advantages of the Invention

The invention relates to an adapter, in particular for a mobile transceiver configuration device, comprising an adapter unit which comprises a communication interface for communication with an external unit by means of a first communication protocol, an adapter interface for communication with an additional unit, in particular the transceiver configuration device, by means of a second communication protocol, and a converter unit for converting between the first communication protocol and the second communication protocol.

It is proposed that the adapter has a power supply unit for the autonomous power supply of at least the adapter unit.

Such a design can provide a high degree of flexibility. In particular, an advantageous mobility and/or a particularly flexible deployment of an adapter can be achieved by means of an autonomous power supply of at least one adapter unit. In addition, the versatility of the adapter can be increased, particularly with respect to its use and/or with respect to a communication link to a further unit, for example at least one transceiver interface, and/or at least one external unit. In addition, a highly versatile range of connection options between external units and the additional unit can be obtained, since the adapter can preferably be used for communication with external units which have specific ports, such as Lightning® ports, that are different from the transceiver configuration device. The adapter can thus be used universally in any type of system, preferably optical systems. In addition, a very compact adapter can be provided, which in turn allows the storage and transport of the adapter to be significantly improved. In addition, efficiency can be improved, advantageously with regard to performance efficiency and/or product efficiency. By means of a power supply unit, it is possible to supply power at least to the adapter autonomously, so that an external power supply source for the operation of the adapter can preferably be omitted. It would be conceivable that by means of the power supply unit, a preferably wireless communication link can be provided between the external unit and the adapter, in particular the adapter unit.

In the present case, an adapter is provided which can supply itself with power independently by means of the power supply unit in at least one operating state. The power supply unit is designed for autonomously supplying at least the adapter unit with power, wherein the power supply unit provides power, preferably in particular independently of an external power supply source, for example, the external unit and/or the additional unit, at least to the adapter unit.

The adapter can be part of a transceiver system. The transceiver system, in particular an optical transceiver system, is advantageously designed for configuring and/or reconfiguring at least one transceiver. The transceiver system can be designed for carrying out a test operation, in particular for testing a transceiver, and/or for carrying out a measurement operation, in particular for measuring and/or calibrating the transceiver and/or for measuring and/or calibrating another object by means of the transceiver. Preferably, the external unit and/or the additional unit and/or the transceiver is part of the transceiver system. The transceiver system could be, for example, an SFP, in particular an SFP-DD, SFP+, SFP28 and/or cSFP, and/or a CFP, in particular, a CFP2, CFP4 and/or CFP8, and/or a QSFP, in particular a QSFP+, QSFP14, QSFP28, QSFP56, and/or QSFP-DD, and/or an XFP and/or OSFP transceiver system. The transceiver system could provide at least one data transmission system and/or a communication system for the external unit, the additional unit and/or at least the transceiver.

The adapter is preferably designed as an accessory and/or retrofit part. This allows for a particularly high degree of flexibility and improved convenience. The adapter is preferably mobile, in particular portable. The additional unit is preferably a transceiver configuration device for configuring the transceiver. It would be conceivable for the adapter and/or the transceiver configuration device to form a transceiver interface of the transceiver system. In particular, the adapter is provided for communication with at least the transceiver configuration device. The transceiver interface may potentially be a stationary device. Preferably, the transceiver interface is implemented as a mobile device, in particular as a handheld and/or a hand-held unit.

The adapter can allow communication between the external unit and the additional unit, preferably the transceiver configuration device. In the operating state the transceiver configuration device can communicate with the external unit at least by means of the communication interface via the adapter.

If a transceiver interface is present, in particular if the transceiver interface consists of at least the adapter and the transceiver configuration device, the transceiver interface could have a configuration unit for configuring the transceiver. The adapter and/or the transceiver configuration device can at least partially comprise the configuration unit. In particular, the configuration unit is at least partially designed integrally, preferably as a single part, with the adapter and/or the transceiver configuration device. The adapter and/or the transceiver configuration device can comprise at least one unit and/or at least one element of the configuration unit. Preferably, the adapter and the transceiver configuration device jointly comprise the configuration unit. It is possible for the transceiver configuration device and/or the adapter to comprise the entire configuration unit.

The transceiver interface is in particular an electrical and/or electronic and preferably mobile device, which is designed for the configuration and/or reconfiguration of the transceiver. The configuration should be advantageously understood here to mean programming, in particular reprogramming, of the transceiver, preferably an encoding and/or an identifier of the transceiver. Alternatively and/or additionally, the configuration of the transceiver, in particular by means of the configuration unit, could comprise performing a tuning and/or a test operation, in particular a tuning and/or a test of the transceiver, and/or performing a measurement, in particular for measuring and/or calibrating the transceiver, and/or measuring and/or a calibrating another object by means of the transceiver. The tuning could be, in particular, a wavelength tuning. Advantageously, the configuration unit changes the configuration, in particular the encoding and/or the identifier, of the transceiver. The configuration unit could modify, recode, reprogram and/or adapt the configuration of the transceiver, in particular to different hardware types and/or hardware configurations, to advantageously enable the use of the transceiver with different hardware, such as from different hardware manufacturers. Preferably, the transceiver is configured to allow the use of the transceiver with different PSEs, in particular by different hardware manufacturers. Preferably, the configuration unit is designed for changing the configuration of the transceiver multiple times and/or repeatedly. In particular, the power supply unit is designed for enabling the configuration of the transceiver by means of the configuration unit in at least the operating state, and preferably independently of the external power supply source, for example, the external unit.

In particular, the adapter unit is part of the configuration unit. In the operating state, the communication interface can establish communication between the external unit and at least the adapter. In particular, the communication link exists between the external unit and the adapter unit, in particular the configuration unit, by means of the communication interface via the adapter. The communication interface communicates with the external unit by means of a first communication protocol in the operating state.

The adapter interface is preferably part of the configuration unit. By means of the adapter interface, in the plugged-in state and in the operating state the adapter communicates with the additional unit, in particular the transceiver configuration device, by means of a second communication protocol.

The converter unit is advantageously designed for converting between the first communication protocol and the second communication protocol for communication between the additional unit and the external unit. In particular, the converter unit converts communication by means of the first communication protocol or the second communication protocol into communication by means of the second communication protocol or the first communication protocol. The converter unit may be designed to enable communication between at least the external unit and the adapter and/or the additional unit. It is conceivable that in the method for operating the adapter, the first communication protocol could be converted into the second communication protocol and vice versa.

The operating state, in particular a normal operating state and/or a test operating state, could have at least one operating mode, in particular a plurality of operating modes. It is conceivable that in the operating state, in particular in at least one first operating mode, the power supply of at least the configuration unit could be provided by means of the external power supply source. The external unit could provide the external power supply source for supplying power at least to the adapter unit. Preferably, the adapter is operable independently of the external power supply source. In the operating state, preferably in a second operating mode and/or at least a third operating mode, the adapter could be autonomously operable by means of the power supply unit independently of the external power supply source. In the second operating mode and/or at least the third operating mode, the power supply unit can provide an autonomous supply of power, in particular independently of the external unit, at least to the adapter unit. For example, the power supply unit could comprise a battery and/or a rechargeable battery. In particular, the power supply unit is a unit for receiving, storing and/or delivering electrical power. The power supply unit may be replaceable and/or rechargeable. It is conceivable that the power supply unit is charged as part of the method for operating the adapter. In at least one operating mode, in particular the first operating mode, the external unit could charge the power supply unit by means of the communication interface.

In the operating state, the transceiver interface could receive a configuration command from the external unit for configuring the transceiver. The external unit is an electronic external device, preferably designed as an operating unit and/or control unit, which is intended in particular for operating and/or controlling the transceiver interface, and preferably for configuring the transceiver. The external unit can be a terminal device, advantageously a mobile device. The external unit could be, for example, a computer, in particular a permanently installed one, and/or a laptop and/or a convertible and/or a mobile phone, in particular smartphone, and/or a tablet and/or a phablet and/or a personal digital assistant (PDA) and/or an equivalent electronic device. The operation and/or control of the transceiver interface and/or the configuration of the transceiver may possibly take place directly by means of a browser, in particular one that is executable on the external unit.

The external unit could communicate via the communication interface with the adapter and/or the transceiver configuration device, preferably with the configuration unit, in the operating state. The communication interface can transmit at least the configuration command and/or a control command for configuring the transceiver from the external unit at least to the configuration unit of the transceiver interface. By means of the transceiver interface and/or the communication interface, the configuration unit configures the transceiver depending on the configuration command in the operating state. Preferably, the configuration unit changes the encoding and/or identifier of the transceiver depending on the configuration command. It would also be conceivable for the configuration unit to perform the tuning and/or testing of the transceiver depending on the configuration command.

The transceiver configuration device is preferably a mobile, in particular portable, transceiver configuration device. The transceiver configuration device is preferably designed for configuring the transceiver. Preferably, the transceiver configuration device has at least one transceiver interface and a configuration element of the configuration unit, at least for programming the transceiver. The power supply unit can conceivably be additionally designed for the autonomous power supply of at least the configuration element. The configuration element allows the transceiver to be configured. The configuration element can at least program the transceiver. In addition, the configuration element may be designed at least for tuning and/or at least for testing the transceiver. In the operating state, the configuration element can receive the configuration command and/or the control command from the external unit to configure the transceiver. For example, the configuration element could be a chipset for configuring, in particular for programming and/or tuning and/or testing, the transceiver. Advantageously, the configuration element is controlled directly by means of the browser executable on the external unit, which in particular allows installation of a special program and/or special application to be omitted.

The transceiver could be an electric, in particular an electrical-electrical, transceiver or preferably an optical, in particular an optical-electrical, transceiver (OT). If an optical transceiver is used, the transceiver is preferably designed to provide an optical-electrical receiving device and an electrical-optical transmitting device. The optical transceiver could receive at least optical signals from at least one data transmission unit, in particular a fiber, such as an optical fiber, and/or convert the optical signals at least into electrical signals. The transceiver is a plug-in transceiver, in particular a pluggable transceiver. The transceiver could be, for example, an SFP, in particular an SFP-DD, SFP+, SFP28 or cSFP, a CFP, in particular a CFP2, CFP4 or CFP8, a QSFP, in particular a QSFP+, QSFP14, QSFP28, QSFP56 or QSFP-DD, an OSFP or an XFP transceiver system. The transceiver could be designed for arrangement, in particular for connection to, and/or for communication with a power sourcing equipment (PSE) device, wherein the PSE could be, for example, a router and/or a hub and/or advantageously a switch.

The transceiver could be connectable to the transceiver configuration device in a reversible, in particular releasable, and preferably non-destructively releasable manner, and preferably able to be plugged into the transceiver configuration device. The transceiver configuration device could comprise a transceiver interface. The transceiver interface could comprise at least one wire-bound transceiver communication unit, advantageously at least one transceiver slot, for wire-bound communication with the transceiver. The transceiver communication unit, advantageously the transceiver slot, advantageously receives the transceiver at least partially in at least one connected state, in particular a plugged-in state. In the plugged-in state, the transceiver can communicate with the transceiver interface via the transceiver interface. In an unconnected state, at least the transceiver is arranged separately from the transceiver interface.

The term “designed” is to be understood here and in the following to mean specifically programmed, configured and/or equipped. The fact that an object is designed for a specific function, is intended to mean that the object fulfils and/or performs this specific function in at least one application state and/or operating state.

In order to provide a particularly flexible and/or versatile adapter, it is proposed that the communication interface comprises a wireless communication unit, in particular a WPAN communication unit, for wireless communication with the external unit. This also allows a more flexible and versatile communication link to be provided between the adapter and the external unit. In addition, the wireless communication unit may make it possible to omit a wire-bound communication unit between the adapter and the external unit. This can also achieve an advantageously simple and/or fast communication and/or means of connection, namely also to, in particular mobile, external units, which have either no or only special ports, such as Lightning® ports.

The wireless communication unit can provide a wireless communication link, in particular a wireless data link, between the adapter and at least the external unit. For example, the wireless communication unit could be a Wireless Local Area Network communication unit, or WLAN communication unit. Preferably, the wireless communication unit is configured as a Wireless Personal Area Network communication unit, namely the WPAN communication unit. For example, to establish a communication link from the adapter to at least the external unit, the wireless communication unit could provide an infrared connection, a WLAN connection, a radio connection, an NFC connection, a wireless USB connection, a ZigBee connection and/or preferably a Bluetooth connection. The wireless communication unit could provide the wireless communication link between the adapter and at least the external unit at a distance from the adapter to the external unit of not more than 100 m, advantageously not more than 10 m, preferably not more than 1 m, and preferably not more than 10 cm. By means of the WPAN communication unit, the wireless communication link can be provided at a distance from the external unit to the adapter of not more than 50 m, advantageously not more than 10 m, preferably not more than 50 cm and particularly preferably not more than 10 cm. Preferably, the adapter communicates with the external unit using Bluetooth Low Energy (BLE). The wireless communication unit could comprise a BR/EDR controller and/or LE controller. The Bluetooth connection can be a BLE connection, such as a BLE 4.0 connection and/or a BLE 5.0 connection and/or a higher connection.

The wireless communication link is optionally switchable on and off. It would be conceivable for the adapter to have an operating element which is designed for activating at least the wireless communication link between the external unit and the adapter. By means of the operating element, an operator can switch between the operating modes in the operating state, in particular the first operating mode and/or the second operating mode and/or at least the third operating mode. The operating element can be movable between at least three positions, the three positions being in particular assigned to at least the three operating modes. In at least the third operating mode, the wireless communication unit could provide the wireless link for communication between the adapter and at least the external unit.

If the communication interface has at least one wire-bound communication unit, preferably a USB communication unit, for wire-bound communication with the external unit, a particularly convenient, advantageously stable, communication link can be provided between the external unit and the adapter. In addition, flexibility with regard to communication with the external unit can be increased, since in addition to further communication options, for example by means of a wireless communication unit, a communication interface can also preferably comprise a wire-bound communication unit. In addition, the wire-bound communication unit may make it possible to omit the wireless communication unit for wireless communication between the adapter and the external unit. Furthermore, it would be conceivable to use the wire-bound communication unit to preferably provide communication with external units which have special ports, such as Lightning® ports.

The wire-bound communication unit preferably forms a wire-bound connection interface, in particular a wire-bound data interface between the adapter and at least the external unit. The wire-bound communication unit, in particular the USB communication unit, can be implemented, for example, as a type-A plug, type-B plug, type-C plug, mini-plug, mini A-plug, mini-B plug, micro-plug, micro-A plug and/or micro-B plug and/or advantageously as a type-A socket, type-C socket, mini-socket, mini-AB socket, mini-B socket, micro socket, micro-AB socket, micro-B socket, and/or preferably as a USB-C communication unit. Preferably, the USB-C communication unit is a USB-C socket, into which a USB-C plug of the external unit can be inserted. In the operating mode, the configuration of the transceiver by means of the external unit can be carried out via at least the wire-bound communication unit. Advantageously, in the method for operating the adapter, the external unit is connected by means of the wire-bound communication unit to the adapter, in particular the adapter unit. In the plugged-in state, the external unit can be connected to the adapter by means of the wire-bound communication unit. Preferably, the communication, in particular the data transmission, between the external unit and at least the adapter, in particular the adapter unit, in the first operating mode and/or at least the second operating mode takes place via the wire-bound communication unit.

It would be conceivable for the adapter to communicate with the additional unit in the operating state via a wireless adapter communication unit of the adapter unit. The adapter interface preferably comprises at least one wire-bound adapter communication unit, in particular a USB adapter communication unit, for wire-bound communication with the additional unit. This means that a particularly convenient adapter can be provided, since an advantageously stable communication link between the adapter and the additional unit can be provided by means of the wire-bound adapter interface. In addition, flexibility with regard to a communication link between the adapter and the additional unit can be further increased.

The wire-bound adapter communication unit preferably forms a wire-bound connection interface, in particular a wire-bound data interface, between the additional unit and at least the adapter. In the operating mode, the adapter can communicate with the additional unit via the wire-bound adapter communication unit. Preferably, the communication, in particular the data transmission, between the external unit and at least the additional unit in the first operating mode and/or at least the second operating mode takes place via the wire-bound adapter communication unit. The external unit could transmit at least the configuration command to the transceiver configuration device, in particular the configuration element, via the wire-bound adapter communication unit. The adapter could be permanently connected to the additional unit by means of the wire-bound adapter communication unit. Preferably, the adapter can be connected to the additional unit in a reversible, in particular releasable, and preferably non-destructively releasable manner, and is preferably able to be plugged into the additional unit. In the plugged-in state, the wire-bound adapter communication unit is connected to the additional unit.

In order to provide a particularly stable, efficient and flexible communication link between an additional unit and an adapter, it is proposed that the wire-bound adapter communication unit has a plug connector element which can be directly connected to the additional unit. This means that both flexibility and convenience can be further increased, namely due to the fact that the adapter can be connected easily and quickly by means of a connector element, advantageously reversibly, to the additional unit if required. This can also ensure a secure and/or stable mounting and/or connection of the adapter to the additional unit. In the case of a direct connection by means of the plug connector element, a lead, in particular a cable and/or a conductor track, between the adapter and the additional unit can also preferably be omitted.

Preferably, the adapter can be connected to the additional unit in a reversible, in particular releasable, and preferably non-destructively releasable manner, namely preferably being able to be plugged into the additional unit. In the plugged-in state, the adapter is connected to the additional unit by means of the plug connector element directly, preferably wirelessly.

The wire-bound adapter communication unit, in particular the USB adapter communication unit, can be implemented, for example, as a type-A plug, type-B plug, type-C plug, mini-plug, mini A-plug, mini-B plug, micro-plug, micro-A plug and/or micro-B plug and/or advantageously as a type-A socket, type-C socket, mini-socket, mini-AB socket, mini-B socket, micro socket, micro-AB socket, micro-B socket, and/or preferably as a micro-USB adapter communication unit. Preferably, the wire-bound adapter communication unit, in particular the plug connector element, is a micro-USB plug which can be plugged into a micro-USB mating socket of the additional unit. The micro-USB mating socket of the additional unit is preferably recessed in the device housing. Advantageously, in the method for operating the adapter, the wire-bound adapter communication unit, preferably the plug connector element, is plugged into the additional unit.

In a preferred embodiment, it is proposed that the power supply unit is additionally designed for the autonomous power supply of at least the additional unit. This can further enhance the flexibility and versatility of an adapter. In addition, the power supply unit can be flexibly connected to the additional unit by means of the adapter if required, in particular for the autonomous provision of power. In addition, the efficiency with regard to power and/or energy efficiency can be increased, since the power supply unit can be connected to the additional unit, for example, a transceiver configuration device, in particular the transceiver configuration device, only when required to provide the autonomous power supply, preferably for configuring a transceiver.

Advantageously, the additional unit is supplied with power in the method for operating the adapter. In the operating state, the power supply unit can autonomously supply at least the adapter unit with power in order to preferably provide the communication link, in particular the wireless communication link, between the adapter and at least the external unit by means of the wireless communication unit, in particular the WPAN communication unit. By means of the adapter, the power supply unit could be flexibly connectable to the additional unit, in particular if the operator requires it.

In order to increase flexibility and convenience even further, it is proposed that the power supply unit is additionally designed to provide autonomous power supply of at least the external unit. Thus, the external unit, for example a mobile phone and/or a tablet, can be supplied with power and preferably charged in an operating state. In the operating state, the power supply unit could additionally supply the external unit with power. Advantageously, the external unit is supplied with power in the method for operating the adapter. In particular, the external unit, for example, the mobile phone and/or the tablet, can be charged by means of the power supply unit in the operating state.

It is further proposed that the adapter unit has a display unit which is designed for displaying at least an operating status and/or an operating mode. This can increase convenience with regard to user-friendliness. In addition, a high flexibility of an adapter can be provided, because the display unit can display different operating states and/or operating modes of the adapter.

Preferably, the adapter housing, in particular the operating element, comprises the display unit. It would be conceivable that the display unit comprises a light source, for example a light-emitting diode (LED), an organic light-emitting diode (OLED) and/or electronic paper (e-paper, ePaper). Preferably, the display unit, in particular the light source, provides an RGB color system. In the operating state, the power supply unit can autonomously supply at least the display unit with power. In addition, it would be conceivable that the adapter unit has an acoustic output unit for the acoustic output of at least one signal to the operator.

In the operating state the display unit can display an operating status with regard to at least one operating mode of the operating modes, in particular the first operating mode and/or the second operating mode and/or at least the third operating mode. The display unit could potentially display the operating status and/or operating mode using different colors. For example, the display unit could emit yellow light in the first operating mode and/or blue light in the second operating mode and/or green light in the third operating mode. With regard to the operating status, the display unit could flash and/or remain continuously lit during the operating state. The operating state could be, for example, a state in which the adapter searches for a communication link with the external unit, in particular by means of the wireless communication unit, and/or attempts to establish the same. The display unit, in particular the light source, could flash when the adapter is not connected to the external unit. If the communication link exists, in particular the wireless communication link and/or the wire-bound communication link, between the adapter and the external unit, the display unit could indicate this operating status by means of a permanently illuminated display, in particular a permanent illumination of at least the light source.

In the first operating mode, for communication with the adapter the external unit may be connected by means of the wire-bound communication unit to the adapter, in particular to the adapter unit. The data transmission and/or communication between the external unit and the adapter can be wire-bound, in particular passive. In addition, in the first operating mode the external unit can at least supply the adapter unit with power, in particular by means of the wire-bound communication unit. For example, the display unit could indicate the first operating mode using yellow light.

For example, the display unit could indicate the second operating mode using blue light. In the second operating mode, for communication with the adapter, in particular the adapter unit, the external unit is preferably connected via the wire-bound communication unit. In the second operating mode, the power supply unit can provide an autonomous supply of power, in particular independently of the external unit, at least to the adapter unit.

To distinguish the third operating mode from at least the first operating mode and/or the second operating mode, the display unit could light up green in the third operating mode. In at least the third operating mode, the power supply unit can provide an autonomous supply of power at least to the adapter unit. This allows the wireless communication unit to provide the wireless link for communication between the adapter and the external unit in at least the third operating mode. Preferably, the external unit is connected to the adapter by means of the Bluetooth connection in the third operating mode.

In addition, it is proposed that the adapter has a longitudinal extension of not more than 200 mm, advantageously not more than 150 mm, preferably not more than 100 mm and particularly preferably not more than 80 mm. In this context, a “longitudinal extension” of an object is to be understood as an extension of the object in a longitudinal extension direction of the object. The longitudinal extension direction of the object is a direction parallel to a longest edge and/or side of an in particular imaginary, smallest cuboid that just encloses the object. As a result, an advantageously compact and/or mobile adapter can be provided, and flexibility with regard to the use and/or transport of the adapter can be increased.

In order to further increase convenience and/or flexibility, it is proposed that the adapter has a transverse extension of not more than 120 mm, advantageously not more than 60 mm, preferably not more than 40 mm and particularly preferably of not more than 30 mm. In this context, a “transverse extension” of an object is to be understood as an extension of the object in a transverse extension direction of the object. The transverse extension direction of the object is a direction parallel to a second-longest edge and/or side of an in particular imaginary, smallest cuboid that just encloses the object.

Advantageously, the adapter, in particular an outer housing of the adapter, is at least substantially cuboidal in shape.

In order to provide particularly high convenience and flexibility with regard to the mobility of an adapter, it is proposed that the adapter has a thickness of not more than 80 mm, advantageously not more than 40 mm, preferably not more than 30 mm and particularly preferably not more than 20 mm.

In addition, the invention is based on a method for operating an adapter, in particular an aforementioned adapter, having an external unit, in particular the aforementioned external unit, wherein the adapter has an adapter unit with a communication interface for communication with the external unit.

It is proposed that at least the adapter unit is autonomously supplied with power. Such a method can advantageously provide particularly high flexibility in the operation of an adapter. In particular, an advantageous mobility and/or a particularly flexible deployment of the adapter can be achieved by means of an autonomous power supply of at least an adapter unit of the unit. In addition, the versatility of the adapter can be increased, particularly with respect to its use and/or with respect to a communication link to at least one additional unit and/or at least one external unit.

It is also proposed that the communication interface has a WPAN communication unit for wireless communication with the external unit and that the external unit is at least partially placed on the adapter. This can further increase flexibility and convenience by providing a particularly simple and quick connection between an adapter and an external unit. The external unit is advantageously placed at least partially on the adapter. In the arranged state, the external unit may be at least partially arranged on the adapter and/or the transceiver configuration device. It would be conceivable for the external unit to be placed on the adapter and/or the transceiver configuration device in an amount of at least 5%, advantageously at least 10%, preferably at least 30% and particularly preferably at least 50%.

In this document, ordinal words, such as “first” and “second”, which are placed before certain terms, are used solely to distinguish between method steps and/or objects and/or to assign objects to each other and do not imply the existence of a total number and/or order of precedence of the objects and/or method steps. In particular, a “second” object and/or method step does not necessarily imply the existence of a “first” object and/or method step.

The adapter, the transceiver system and the method for operating an adapter shall not be restricted to the application and embodiment described above. In particular, in order to fulfil a function described herein the adapter and/or the transceiver system and/or the method for operating the adapter may comprise a number of individual elements, components, units and/or method steps that differs from a number specified herein. In addition, with regard to the ranges of values specified in this document, values within the aforementioned limits should also be regarded as disclosed and as usable as desired.

### DRAWINGS

Further advantages are obtained from the following description of the drawings. The drawings illustrate an exemplary embodiment of the invention. The drawings, the description and the claims contain numerous features in combination. The person skilled in the art will also advantageously consider the features individually and combine them to form further meaningful combinations.

Shown are:

FIG. 1 a transceiver system having a transceiver interface, which comprises at least one adapter, having an external unit and at least one transceiver in a plugged-in state,

FIG. 2 the transceiver system with the transceiver interface and at least the transceiver in an unconnected state,

FIG. 3 a detail view of a transceiver interface having an additional unit designed as a transceiver configuration device and an adapter in the plugged-in state,

FIG. 4 a further detail view of the transceiver interface in accordance with FIG. 3,

FIG. 5 a detail view of the transceiver configuration device,

FIG. 6 a detail view of the adapter,

FIG. 7 a further detail view of the adapter in accordance with FIG. 6,

FIG. 8 a schematic overview of the transceiver system and

FIG. 9 a schematic method flow diagram illustrating a method for operating the adapter.

### DESCRIPTION OF THE EXEMPLARY EMBODIMENT

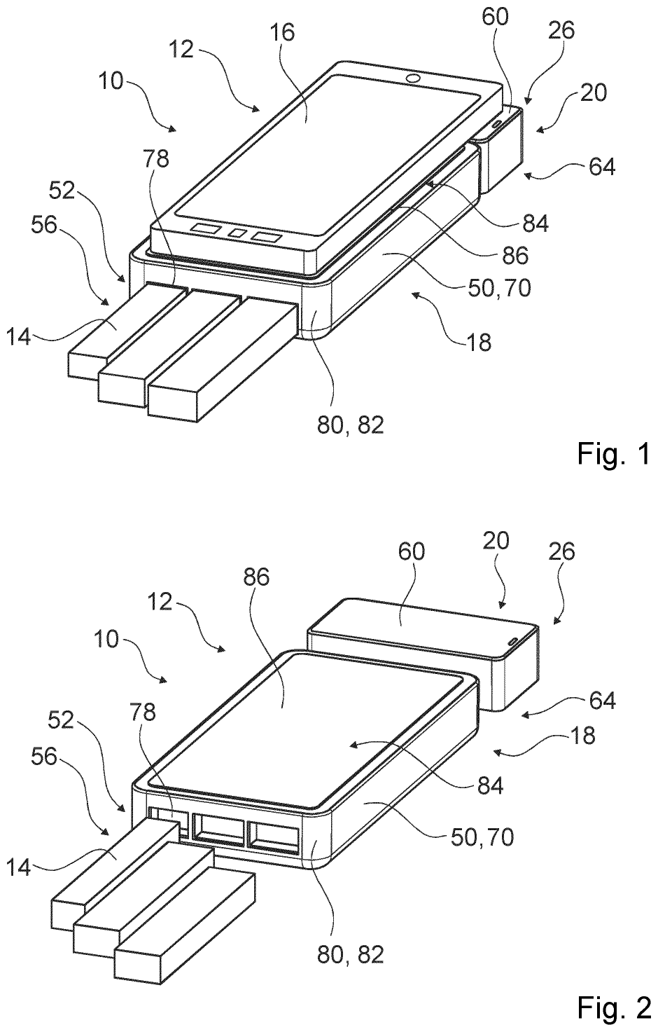

FIG. 1 shows a transceiver system 10 having an adapter 60, an external unit 16 and an additional unit 70. In the present case, the additional unit 70 is designed by way of example as a transceiver configuration device 50. In this embodiment, the adapter 60 and the transceiver configuration device 50 are part of a transceiver interface 12 of the transceiver system 10. The transceiver system 10 also comprises at least one transceiver 14. The transceiver system 10 is implemented as an optical transceiver system and is designed to configure and/or reconfigure the transceiver 14. The transceiver system 10 in this case is an SFP transceiver system. Alternatively and/or additionally, the transceiver system 10 could be a CFP, an OSFP, an XFP, a QSFP and/or a QSFP-DD transceiver system. The transceiver system 10 provides at least a data transmission system and/or a communication system for the external unit 16, the transceiver interface 12 and/or at least the transceiver 14.

In the present case, three transceivers 14 are shown by way of example, wherein only one transceiver is provided with a reference sign and the following description refers to this transceiver by way of example. The transceiver 14 is a pluggable transceiver. The transceiver 14 could be a CFP, XFP, OSFP, QSFP, or QSFP-DD transceiver. In the present exemplary embodiment, the transceiver 14 is implemented as an SFP transceiver. The transceiver interface 12 comprises a transceiver interface 52 (cf. FIGS. 1 to 3 and 8). In this case, the transceiver interface 52 has at least one wire-bound transceiver communication unit 56 for wire-bound communication between the transceiver interface 12 and the transceiver 14 (cf. FIGS. 1 to 3 and 8). The wire-bound transceiver communication unit 56 comprises at least one transceiver slot 78 for at least the transceiver 14 (cf. FIGS. 1 to 3). In the present case, the wire-bound transceiver communication unit 56 comprises, for example, three transceiver slots, wherein, in the interests of clarity, only one transceiver slot is provided with a reference sign. The transceiver 14 can be connected to the transceiver interface 12 in a reversible, releasable, specifically non-destructively reversible, manner. In the present case, the transceiver 14 can be plugged into the transceiver interface 12. In contrast to FIG. 2, FIG. 1 shows a connected state, specifically a plugged-in state, in which at least the transceiver 14 is connected to the transceiver interface 12, in the present case plugged into the transceiver interface 12 by means of the transceiver slot 78. In the plugged-in state, the transceiver 14 can communicate with the transceiver interface 12 via the transceiver interface 52. FIG. 2 shows an unconnected state, in which at least the transceiver 14 is arranged separately from the transceiver interface 12.

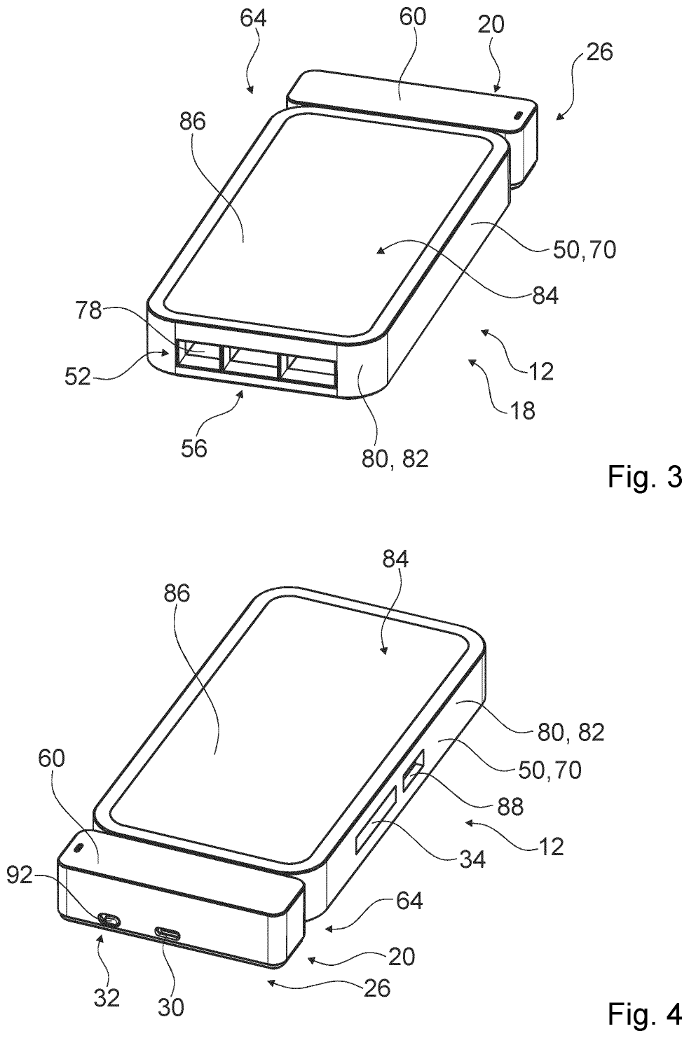

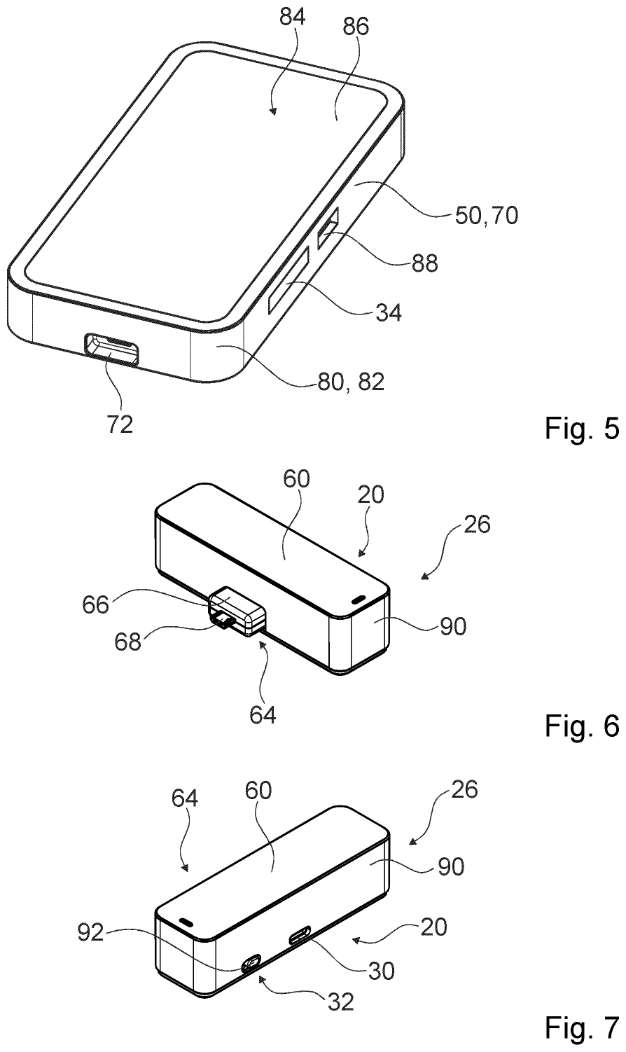

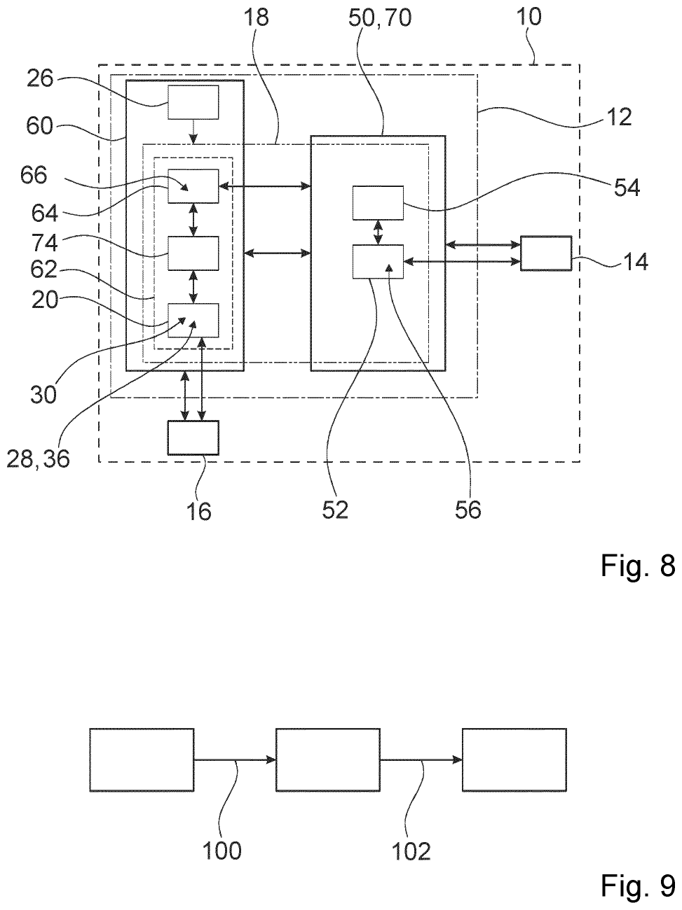

For better clarity and illustration of the association of the units and elements as well as the interaction of the units and elements with one another, a schematic overview of the transceiver system 10 is shown in FIG. 8. FIGS. 3 and 4 each show detail views of the transceiver interface 12 with the adapter 60 and the transceiver configuration device 50 in the plugged-in state. FIG. 5 shows a detail view of the transceiver configuration device 50. The detail views of the adapter 60 according to FIGS. 6 and 7 illustrate the structure of the adapter 60. In FIG. 9, a schematic method flow diagram shows an example of a method for operating the adapter 60.

The case discussed here refers to a mobile transceiver interface 12 (cf. FIGS. 1 to 4 and 8). The transceiver configuration device 50 is designed for configuring the transceiver 14. In order to provide high flexibility and increased convenience, the transceiver configuration device 50 is implemented as a mobile handheld device (cf. FIGS. 1 to 5). In the present case, the transceiver configuration device 12 comprises the wire-bound transceiver communication unit 56, specifically at least the transceiver slot 78. In the plugged-in state, at least the transceiver 14 is plugged into the transceiver configuration device 50, namely via the transceiver slot 78 (cf. FIG. 1).

In an operating state, the transceiver interface 52 provides a configuration connection between the transceiver configuration device 50 and the transceiver 14. Alternatively and/or additionally, the transceiver interface 52 provides a user data connection to the transceiver 14 in the operating state. The user data connection here is an Internet connection, preferably a high-speed Internet connection. Alternatively and/or additionally, the user data connection could be a LAN connection.

The transceiver configuration device 50 has a device housing 80 (cf. FIGS. 1 to 5). At least the transceiver interface 52 is arranged in the device housing 80. The device housing 80 is configured in this case as an external housing 82. The device housing 82 has a holding unit 84, which is designed for holding the external unit 16 (cf. FIGS. 1 to 5). The holding unit 84 is at least substantially flat. A main extension plane of the holding unit 84 is arranged at least substantially parallel to a main extension plane of the device housing 80. The holding unit 84 is formed integrally with a top wall of the device housing 80. In the present case, the holding unit 84 is materially bonded to the top wall of the device housing 80. The external unit 16 can be at least partially placed on top of the holding unit 84. FIG. 1 shows an arranged state of the external unit 16, in which the external unit 16 rests at least partially on the holding unit 84. To increase the static friction, namely in the region of a contact area with the external unit 16, the holding unit 84 has at least one static friction element 86 (cf. FIGS. 1 to 5). Alternatively, in the connected state the external unit 16 could be connected to the transceiver configuration device 50 by means of an additional wire-bound communication unit 88. In this case, the transceiver configuration device 50 comprises the additional wire-bound communication unit 88 (see FIG. 5).

The external unit 16 is an electronic external device which is designed as an operating unit and/or control unit and is designed for controlling the transceiver interface 12, preferably the transceiver configuration device 50, and/or for configuring the transceiver 14. For example, the external unit 16 is designed as a mobile terminal, in the present case as a mobile phone (cf. FIG. 1). Alternatively, it could potentially also be a permanently installed computer.

To increase flexibility, specifically with regard to versatility in the use of the transceiver configuration device 50 with the external unit 16, the adapter 60a is designed as a retrofit part and/or accessory, specifically for the mobile transceiver configuration device 50 (cf. FIGS. 6 and 7). The adapter 60 is designed for connection to at least the transceiver configuration device 50. In the plugged-in state according to FIG. 1, the adapter 60 is connected to the transceiver configuration device 50. In the unconnected state, the adapter 60 is arranged separately from the transceiver configuration device 50 (cf. FIG. 2). FIG. 1 shows that the external unit 16 is arranged at least partially on the adapter 60 in the arranged state, namely resting on the adapter 60. In this case, the external unit 16 covers at least 15% of the adapter 60.

The adapter 60 has an adapter housing 90 (cf. FIGS. 6 and 7). The adapter housing 90 of the adapter 60 is designed in the present case in a cuboid shape. For example, the adapter 60 has a longitudinal extension of not more than 200 mm. In the present case, the longitudinal extension is at least substantially 86 mm. The adapter 60 has a transverse extension of not more than 120 mm. In this exemplary embodiment, the adapter 60, namely the outer housing 82, has a transverse extension of 50 mm, wherein a transverse extension of 35 mm is also possible. The adapter 60 has a thickness of not more than 80 mm. In the present case, the thickness of the adapter 60, namely the adapter housing 82, is at least substantially 25 mm. The term “at least substantially” is intended to mean that a value and/or an orientation deviates by a maximum of 10%, advantageously by a maximum of 5% and preferably by a maximum of 1% from the described value and/or the described orientation.

For configuring the pluggable transceiver 14, the transceiver interface 12 has a configuration unit 18 (cf. FIGS. 1 to 3 and 8). FIG. 8 shows that the configuration unit 18 is formed at least partly integrally with the transceiver configuration device 50 and the adapter 60. In this case, the adapter 60 and the transceiver configuration device 50 together comprise the configuration unit 18a. The adapter 60 and the transceiver configuration device 50 comprise at least one unit and/or at least one element of the configuration unit 18. To provide the autonomous power supply of at least the configuration unit 18, the transceiver interface 12 has a power supply unit 26 (cf. FIGS. 1 to 4 and 8). In the operating state the power supply unit 26 provides an autonomous power supply to at least the configuration unit 18 for at least 30 minutes. Thus, the power supply to at least the configuration unit 18 can be provided independently of an external power supply source, for example the external unit 16. In this embodiment, the adapter 60 comprises the power supply unit 26 for the autonomous power supply of at least the configuration unit 18 (cf. FIGS. 1 to 4 and 6 to 8).

At least for programming the transceiver 14, the transceiver configuration device 50 comprises a configuration element 54 of the configuration unit 18 (cf. FIG. 8). The power supply unit 26 is additionally provided for the autonomous power supply of at least the configuration element 54. The configuration element 54 allows the transceiver 14 to be configured. The transceiver 14 can be programmed and/or tuned and/or tested, for example, in the operating state. In the operating state, the configuration element 54 receives a configuration command and/or a control command from the external unit 16 for configuring the transceiver 14. In the present case, the configuration element 54 is controlled directly by means of a browser executable on the external unit 16.

The configuration unit 18 has a communication interface 20 for communication with the external unit 16 (cf. FIGS. 1 to 4 and 8). The communication interface 20 communicates with the external unit 16 by means of a first communication protocol. The communication interface 20 comprises a wireless communication unit 28 for wireless communication with the external unit 16 (cf. FIG. 8). The wireless communication unit 28 is designed to provide, for example, an infrared connection, a WLAN connection, a radio connection, an NFC connection, a Bluetooth connection, a ZigBee connection and/or a wireless USB connection between the external unit 16 and the transceiver interface 12, in this case between the external unit 16 and at least the adapter 60. In this embodiment, the wireless communication unit 28 is configured as a WPAN communication unit 36 (cf. FIG. 8). In the operating state the WPAN communication unit 36 provides at least one Bluetooth connection for communication between the external unit 16 and the configuration unit 18. In the present case, the external unit 16 communicates at least with the adapter 60 by means of the WPAN communication unit 36 in the operating state (cf. FIG. 8).

For alternative communication of the external unit 16 with the transceiver interface 12, the communication interface 20 has at least one wire-bound communication unit 30, namely a USB communication unit for wire-bound communication with the external unit 16 (cf. FIG. 8). The wire-bound communication unit 30 forms part of the transceiver interface 12. In the present case, the adapter 60 comprises the wire-bound communication unit 30, namely the USB communication unit (cf. FIGS. 4 and 7). In this example, the USB communication unit is designed as a USB-C communication unit. A USB-C plug of the external unit 16 can be plugged into the USB-C communication unit in the form of a USB-C plug socket to enable communication between the external unit 16 and the transceiver interface 12. In at least the operating state, the communication between the external unit 16 and the transceiver interface 12, in this case at least the adapter 60, can take place by means of the wire-bound communication unit 30. In addition, the power supply unit 26 is provided for the autonomous power supply of at least the external unit 16.

The adapter 60 comprises an adapter unit 62. In the present case, the adapter unit 62 is part of the configuration unit 18 (cf. FIG. 8). The adapter unit 62 in the present case comprises the communication interface 20 for communication with the external unit 16. In this exemplary embodiment, the configuration unit 18 communicates with the external unit 16 by means of the wireless communication unit 28 in the operating state. In the present case, the adapter 60 comprises the power supply unit 26 for the autonomous power supply of at least the adapter unit 62.

So that the adapter 60 can communicate with the additional unit 70, in this case with the transceiver configuration device 50, the adapter unit 62 has an adapter interface 64 (cf. FIGS. 1 to 4 and 6 to 8). In this case, to enable wire-bound communication with the transceiver configuration device 50, the adapter interface 64 has at least one wire-bound adapter communication unit 66, which is designed, for example, as a USB adapter communication unit (cf. FIGS. 6 and 8). FIG. 6 illustrates that the wire-bound adapter communication unit 66 has a plug connector element 68, which can be connected directly to the transceiver configuration device 50. The USB adapter communication unit in this case is a micro-USB adapter communication unit, wherein the plug connector element 68 is configured as a micro-USB plug connector. The plug connector element 68 can be plugged into a mating socket 72 of the transceiver configuration device 50, in the present case into a micro-USB mating socket of the transceiver configuration device 50. The mating plug socket 72 of the transceiver configuration device 50 is recessed in the device housing. The adapter 60 can be connected to the transceiver configuration device 50 by means of the plug connector element 68 in a reversible, in particular releasable, and preferably non-destructively releasable manner, namely preferably able to be plugged into the transceiver interface 50. In the plugged-in state, the wire-bound adapter communication unit 66 is directly connected by means of the plug connector element 68 to the transceiver configuration device 50 (cf. FIGS. 1, 3 and 4). By means of the adapter interface 64, in the plugged-in state and in the operating state the adapter 60 communicates with the additional unit 70, in the present case with the transceiver configuration device 50, by means of a second communication protocol.

The adapter unit 62 comprises a converter unit 74, which is designed to enable communication between the external unit 16 and at least the adapter 60. The converter unit 74 also allows communication between the adapter 60 and the transceiver configuration device 50. The converter unit 74 is designed for converting between the first communication protocol and the second communication protocol. In this case, the converter unit 74 converts communication by means of the first communication protocol or the second communication protocol into communication by means of the second communication protocol or the first communication protocol.

The wireless communication link can be optionally switchable on and off. The transceiver interface 12, in this case the adapter 60, has an operating element 92 which is designed at least for activating the wireless communication link to the external unit 16 (cf. FIGS. 4 and 7). By means of the operating element 92, at least one operating mode of the operating state can be set. The operating state has a plurality of operating modes. The operating element 92 in this case can be moved between at least three positions.

The configuration unit 18 has a display unit 32, which is designed for displaying at least one operating status. In this case the display unit 32 is part of the adapter 60 (cf. FIGS. 4 and 7). The display unit 32 is integrated in the operating element 92.

The operating state has a plurality of operating modes. The display unit 32 is designed for displaying at least one operating status with respect to at least one operating mode of the operating modes. In a first operating mode of the operating modes, for communication with the transceiver interface 12 the external unit 16 is connected by means of the wire-bound communication unit 30 to the transceiver interface 12, namely the adapter 60 (not shown). The data transmission and/or communication between the external unit 16 and the transceiver interface 12 in the first operating mode is wire-bound, namely passive. In addition, in the first operating mode the external unit 16 can supply at least the configuration unit 18 with power, namely by means of the wire-bound communication unit 30. In addition, the external unit 16 can charge the power supply unit 26 with power in the first operating mode. In this exemplary embodiment, the display unit 32 indicates the first operating mode with yellow-coloured light (not shown).

The display unit 32 indicates a second operating mode of the operating modes, for example, by a blue colour (not shown). In the second operating mode, for communication with the transceiver interface 12, namely the configuration unit 18, the external unit 16 is connected via the wire-bound communication unit 30 to the transceiver interface 12 (not shown). In the second operating mode, the power supply unit 26 provides the autonomous power supply, preferably independently of the external unit 16, of at least the configuration unit 18.

To distinguish a third operating mode of the operating modes from at least the first operating mode and/or the second operating mode, the display unit 32 lights up green in the third operating mode. In the present case, the operating state in the third operating mode is shown in FIG. 1. In at least the third operating mode, the power supply unit 26 provides the autonomous power supply of at least the configuration unit 18 (cf. FIG. 8). In at least the third operating mode, the wireless communication unit 28 provides the wireless communication link for communication between the transceiver interface 12 and the external unit 16 (cf. FIG. 1). In this exemplary embodiment, the external unit 16 is connected by means of the Bluetooth connection to the transceiver interface 12, namely the adapter 60 (cf. FIG. 1) in the third operating mode.

For internal operation and/or control of the configuration unit 18, preferably independently of the external unit 16, the transceiver interface 12 has an operator interface 34 (cf. FIGS. 4 and 5). This means that the control and/or operation by means of the external unit 16 may be omitted. In the operating mode, the power supply unit 26 autonomously supplies at least the operator interface 34 with power.

The method flow diagram shown schematically in FIG. 9 illustrates the method for operating the adapter 60. The method could comprise a plurality of method sub-steps. In the present case, the method for operating the adapter 60 is illustrated in an exemplary manner by means of a first method step 100 and a second method step 102. For communication with the external unit 16 by means of the communication interface 20, the external unit 16 is placed at least partially on the adapter 60 in the first method sub-step 100. The communication link is activated in the second method sub-step 100. In this case, the power supply unit 26 is activated so that at least the adapter unit 62 is supplied with power autonomously by means of the power supply unit 26. Thus, the wireless communication link between the external unit 16 and the adapter 60 can be provided by means of the communication interface 20, wherein the communication interface 20 is formed by the WPAN communication unit 36 for wireless communication with the external unit 16.

### REFERENCE SIGNS

10 transceiver system
12 transceiver interface
14 transceiver
16 external unit
18 configuration unit
20 communication interface
26 power supply unit
28 wireless communication unit
30 wire-bound communication unit
32 display unit
34 operator interface
36 WPAN communication unit
50 transceiver configuration device
52 transceiver interface
54 configuration element
56 transceiver communication unit
60 adapter
62 adapter unit
64 adapter interface
66 wire-bound adapter communication unit
68 plug connector element
70 additional unit
72 mating plug socket
74 converter unit
78 transceiver slot
80 device housing
82 outer housing
84 holding unit
86 static friction element
88 wire-bound communication unit
90 adapter housing
92 operating element
100 first method step
102 second method step

1. An adapter, in particular for a mobile transceiver configuration device, comprising an adapter unit which comprises a communication interface for communication with an external unit by means of a first communication protocol, an adapter interface for communication with an additional unit, in particular the transceiver configuration device, by means of a second communication protocol, and a converter unit for converting between the first communication protocol and the second communication protocol, characterized by a power supply unit for the autonomous power supply of at least the adapter unit.

2. The adapter according to claim 1, characterized in that the communication interface comprises a wireless communication unit, in particular a WPAN communication unit, for wireless communication with the external unit.

3. The adapter according to claim 1, characterized in that the communication interface comprises at least one wire-bound communication unit, in particular a USB communication unit, for wire-bound communication with the external unit.

4. The adapter according to claim 1, characterized in that the adapter interface comprises at least one wire-bound adapter communication unit, in particular a USB adapter communication unit, for wire-bound communication with the additional unit.

5. The adapter according to claim 4, characterized in that the wire-bound adapter communication unit has a plug connector element, which can be connected directly to the additional unit.

6. The adapter according to claim 1, characterized in that the power supply unit is additionally provided for the autonomous power supply of at least the additional unit.

7. The adapter according to claim 1, characterized in that the power supply unit is additionally provided for the autonomous power supply of at least the external unit.

8. The adapter according to claim 1, characterized in that the adapter unit has a display unit (32), which is provided for displaying at least one operating status.

9. The adapter according to claim 1, characterized by a longitudinal extension of not more than 200 mm.

10. The adapter according to claim 1, characterized by a transverse extension of not more than 120 mm.

11. The adapter according to claim 1, characterized by a thickness of not more than 80 mm.

12. The adapter according to claim 1, which is designed as a retrofit part.

13. A transceiver system having an adapter according to claim 1, having the external unit and the additional unit.

14. A method for operating an adapter, in particular according to claim 1, having an external unit, wherein the adapter comprises an adapter unit with a communication interface for communication with the external unit, characterized in that at least the adapter unit is autonomously supplied with power.

15. The method according to claim 14, characterized in that the communication interface comprises a WPAN communication unit for wireless communication with the external unit and the external unit is placed at least partially on the adapter.
